(19) United States
(12) Patent Application Publication
(10) Pub. No.: US 2022/0274873 A1
(43) Pub. Date: Sep. 1, 2022

(54) Insulating Material and Method of its Production

(71) Applicant: FIRST POINT A.S., Hodonin (CZ)

(72) Inventors: Gabriela Chlandová, Borohrádek (CZ); Petr Spaniel, Ceské Mezinci (CZ)

(73) Assignee: FIRST POINT A.S., Hodonin (CZ)

(21) Appl. No.: 17/627,654

(22) PCT Filed: Jun. 9, 2020
(86) PCT No.: PCT/CZ2020/000023

§ 371 Date: Jan. 15, 2022

(30) Foreign Application Priority Data
Aug. 6, 2019 (CZ) PV 2019-507

(51) Int. Cl. C04B 14/22; C04B 24/28; C04B 28/26

(52) U.S. Cl. CPC C04B 14/22; C04B 24/282; C04B 28/26; C04B 2111/2084

(57) ABSTRACT

An insulating material, especially a non-flammable thermally insulating material containing water glass and a plastic component consisting of a mixture containing 43 to 57.5 weight percent of a plastic component, 30 to 47 weight percent of an aqueous solution of silicate, 9 to 11.5 weight percent of hollow glass microspheres, and 0.1 to 1 weight percent of a water glass stabilizer. Method of production of the insulating material, especially method of production of the non-flammable thermally insulating material lying in the fact that, as the first step, a water glass stabilizer is added into the aqueous solution of silicate and, at the same time, a mixture of phenyl methyl diisocyanate and branched polyol is prepared and then the aqueous solution of silicate is intermixed with the mixture of phenyl methyl diisocyanate and branched polyol and thereafter hollow glass spheres are added into the resulting mixture and everything is then thoroughly mixed again.

### TECHNICAL FIELD

The invention relates to an insulating material, especially to a non-flammable thermally insulating material containing water glass and a plastic component, and to method of its production.

### STATE OF THE ART

There exists a wide range of methods known from the existing state of the art where plastics are used as insulating materials, especially in the construction industry. Their disadvantage is their lower fire resistance.

The foam insulating materials, for example, are among those that are widely used for thermal insulation. The most often used material is expanded and extruded polystyrene. This material has good insulating power but it is highly flammable and not vapour-permeable.

The polyurethane foam and polyisocyanurate foam are also materials that are widely used in the construction industry. A disadvantage of these materials is demandingness of their application, UV degradation and, as the case may be, water absorption.

The property that is common to all commonly used insulating materials is their flammability which considerably contributes to the spreading of fire. When heated up and burning, these materials generate a considerable amount of poisonous gases which, as such, are more dangerous than the fire itself.

The patent document CA1064200A describes production of polyurethane foam into which soda water glass is added before foaming in order to reduce flammability. A disadvantage of this material is still high flammability.

Another patent document CN105924942 describes production of polyurethane foam with perlite or hollow glass spheres and phosphoamine retarder. The spheres are to increase rigidity of this material which is highly flammable again.

Another flammable plastic material is known from patent document CN106220819. The material consisting of polyurethane with added spheres and polypropylene glycol is used for making boards.

It is obvious from the state of the art that the main disadvantage of all the materials described above is the fact that the plastic insulating materials known so far are almost always flammable.

The goal of this invention is to formulate an insulating material with high resistance to fire and, at the same time, with resistance to degradation.

### PRINCIPLE OF THE INVENTION

The aforementioned disadvantages are, to a large extent, eliminated and the goals of the invention accomplished by an insulating material, especially by a non-flammable thermally insulating material containing water glass and a plastic component according to the invention the nature of which consists in the fact that the material is a mixture containing 43 to 57.6 weight percent of a plastic component, 30 to 47 weight percent of an aqueous solution of silicate, 9 to 11.5 weight percent of hollow glass microspheres, and 0.1 to 1 weight percent of a water glass stabilizer. An advantage of the insulating material is its high thermal stability, high resistance to fire and considerably higher resistance to degradation. At the same time, the insulating material has excellent fungicidal effects, is environmentally friendly, not harmful to health, it reflects UV radiation well and does not release any organic poisonous substances.

It is advantageous if the plastic component used is polyurethane and, in the most advantageous option, if the polyurethane consists of a mixture of 60 to 70 weight percent of phenyl methyl diisocyanate and 30 to 40 weight percent of branched polyol. This is advantageous because the polyurethane provides the resulting insulating material with elasticity and flexibility.

It is very advantageous if the hollow glass spheres are microspheres of 0.05 to 0.08 mm. These spheres have very thin walls. They touch each other in individual points, and a great number of sharp material interfaces (boundaries) represents resistance to passage of heat. Such a porous system distinguishes itself by a low heat-transfer coefficient and it acts as an excellent thermal insulating material.

According to the first variant, it is advantageous in some applications if the aqueous solution of silicate mentioned in the first variant above is an aqueous solution of sodium silicate.

According to the second variant it can also be advantageous if the aqueous solution of silicate mentioned in the second variant above is an aqueous solution of potassium silicate.

It is very advantageous if the insulating material further contains a water glass hardener, e.g. glycerol mono to tri acetate or their mixture.

It is further advantageous if hydrophilic alkoxyle alkyl ammonia salts are used as the water glass stabilizer.

The aforementioned disadvantages are, to a large extent, further eliminated and the goals of the invention accomplished by method of production of the insulating material, especially method of production of non-flammable thermally insulating material containing water glass and plastic component the nature of which consists in the fact that a water glass stabilizer is, as the first step, added to the aqueous solution of silicate and, at the same time, a mixture of phenyl methyl diisocyanate and branched polyol is prepared. Then, as the second step, the aqueous solution of silicate is intermixed with the mixture of phenyl methyl diisocyanate and branched polyol and, as the third step, hollow glass spheres are added to the resulting mixture and everything is then thoroughly mixed. An advantage is that this method facilitates both making solid products, such as insulating boards, shaped pieces etc., and carrying out liquid applications.

It is advantageous if the water glass hardener is added into the aqueous solution of silicate and water glass stabilizer. The advantage lies in the fact that the hardening rate can be optimized.

It is advantageous if the resulting mixture is then poured in a mould and left as it is until it becomes hardened.

The main advantage of the insulating material and method of its production according to this invention is the fact that it is highly non-flammable. Another advantage is the fact that the water glass used in the material slows down decomposition of the polymer and, at the same time, ensures non-flammability of the mixture as a whole while not affecting the positive properties of polyurethane, especially its plasticity. The mixture of polyurethane, water glass and the spheres forms a non-flammable thermally insulating plastic component which is light, adequately soft, elastic, formable, easy to pour in moulds and not harmful to health. It can also be dyed using common inorganic pigments. In its liquid form, it is very sticky and applicable as a protective layer onto all kinds of underlying surfaces. The layer then protects the surface from water, moulds, mildews, corrosion etc. both mechanically and chemically.

### EXAMPLES OF THE PERFORMANCE OF THE INVENTION

### Example 1

The non-flammable insulating material consists of a mixture that contains 45 weight percent of a plastic component, 43 weight percent of an aqueous solution of sodium silicate, 9.6 weight percent of hollow glass microspheres, 0.1 weight percent of a water glass stabilizer, and 2.3 weight percent of a water glass hardener.

The plastic component is polyurethane which consists of a mixture of 67 weight percent of phenyl methyl diisocyanate and 33 weight percent of branched polyol.

The hollow glass spheres are microspheres of 0.05 mm in size.

The water glass hardener is a mixture of pure glycerol diacetate/triacetate in the ratio of 7:3 volume parts with the concentration of 0.5 to 5 weight percent to the pure water glass.

Hydrophilic alkoxyle alkyl ammonia salts in the form of 98-percent aqueous solution of N,N,N′,N′-Tetrakis (2-hydroxypropyl) ethylene diamine are used as a water glass stabilizer.

Method of production: As the first step, the water glass stabilizer is added into the aqueous solution of sodium silicate. As the second step, the water glass hardener is added into the solution and everything is stirred for 10 minutes. At the same time, the mixture of phenyl methyl diisocyanate and branched polyol is prepared. After that, the aqueous solution of sodium silicate is intermixed with the mixture of phenyl methyl diisocyanate and branched polyol. Then the hollow glass spheres are added to the resulting mixture and everything is thoroughly mixed again.

After that, the resulting mixture is poured in a silicone mould and left as it is until it becomes hardened.

### Example 2

The non-flammable insulating material consists of a mixture that contains 54 weight percent of a plastic component, 34.9 weight percent of an aqueous solution of potassium silicate, 11 weight percent of hollow glass microspheres, and 0.1 weight percent of a water glass stabilizer.

The plastic component is polyurethane which consists of a mixture of 66 weight percent of phenyl methyl diisocyanate and 33 weight percent of branched polyol.

The hollow glass spheres are microspheres of 0.065 mm in size.

The water glass hardener is a mixture of pure glycerol diacetate/triacetate in the ratio of 7:3 volume parts with the concentration of 0.5 to 5 weight percent to the pure water glass.

Hydrophilic alkoxyle alkyl ammonia salts in the form of 98-percent aqueous solution of N,N,N′,N′-Tetrakis (2-hydroxypropyl) ethylene diamine are used as a water glass stabilizer.

Method of production: As the first step, the water glass stabilizer is added into the aqueous solution of sodium silicate. At the same time, the mixture of phenyl methyl diisocyanate and branched polyol is prepared. Then the aqueous solution of sodium silicate is intermixed with the mixture of phenyl methyl diisocyanate and branched polyol. Then the hollow glass spheres are added in the resulting mixture and everything is thoroughly mixed again.

After that, the resulting mixture is poured in a silicone mould and left as it is until it becomes hardened.

### Example 3

The non-flammable insulating material consists of a mixture that contains 57.5 weight percent of a plastic component, 30 weight percent of an aqueous solution of sodium silicate, 11.5 weight percent of hollow glass microspheres, and 0.8 weight percent of a water glass stabilizer, and 0.2 weight percent of a water glass hardener.

The plastic component is polyurethane which consists of a mixture of 60 weight percent of phenyl methyl diisocyanate and 40 weight percent of branched polyol.

The hollow glass spheres are microspheres of 0.08 mm in size.

The water glass hardener is a mixture of pure glycerol diacetate/triacetate in the ratio of 7:3 volume parts with the concentration of 0.5 to 5 weight percent to the pure water glass.

Hydrophilic alkoxyle alkyl ammonia salts in the form of 98-percent aqueous solution of N,N,N′,N′-Tetrakis (2-hydroxypropyl) ethylene diamine are used as a water glass stabilizer.

Method of production: As the first step, the water glass stabilizer and the water glass hardener are added into the aqueous solution of sodium silicate and everything is stirred for 10 minutes. At the same time, the mixture of phenyl methyl diisocyanate and branched polyol is prepared. Then the aqueous solution of sodium silicate is intermixed with the mixture of phenyl methyl diisocyanate and branched polyol. Then the hollow glass spheres are added in the resulting mixture and everything is thoroughly mixed again.

After that, the resulting mixture is poured in a silicone mould and left as it is until it becomes hardened.

### Example 4

The non-flammable insulating material consists of a mixture that contains 43 weight percent of a plastic component, 47 weight percent of an aqueous solution of potassium silicate, 9 weight percent of hollow glass microspheres, and 1 weight percent of a water glass stabilizer.

The plastic component is polyurethane which consists of a mixture of 70 weight percent of phenyl methyl diisocyanate and 30 weight percent of branched polyol.

The hollow glass spheres are microspheres of 0.065 mm in size.

The water glass hardener is a mixture of pure glycerol diacetate/triacetate in the ratio of 7:3 volume parts with the concentration of 0.5 to 5 weight percent to the pure water glass.

Hydrophilic alkoxyle alkyl ammonia salts in the form of 98-percent aqueous solution of N,N,N′,N′-Tetrakis (2-hydroxypropyl) ethylene diamine are used as a water glass stabilizer.

Method of production: As the first step, the water glass stabilizer is added into the aqueous solution of sodium silicate. At the same time, the mixture of phenyl methyl diisocyanate and branched polyol is prepared. Then the aqueous solution of sodium silicate is intermixed with the mixture of phenyl methyl diisocyanate and branched polyol. Then the hollow glass spheres are added in the resulting mixture and everything is thoroughly mixed again.

After that, the resulting mixture is poured in a silicone mould and left as it is until it becomes hardened.

### INDUSTRIAL APPLICATION

The insulating material according to this invention has a wide range of use not only in the building industry but also in the automotive and electrotechnical industries as it can either be used for making individual insulating products or it can be applied directly onto individual surfaces (e.g. metals) to be protected.

1. A non-flammable thermally insulating material comprising water glass and a plastic component comprising 43 to 57.5 weight percent of a plastic component, 30 to 47 weight percent of an aqueous solution of silicate, 9 to 11.5 weight percent of hollow glass microspheres, and 0.1 to 1 weight percent of a water glass stabilizer.

2. The insulating material according to claim 1, wherein the plastic component is polyurethane.

3. The insulating material according to claim 1, wherein the plastic component is polyurethane comprising a mixture of 60 to 70 weight percent of phenyl methyl diisocyanate and 30 to 40 weight percent of branched polyol.

4. The insulating material according to claim 1, wherein the hollow glass spheres are microspheres 0.05 to 0.08 mm in size.

5. The insulating material according to claim 1, wherein the aqueous solution of silicate is an aqueous solution of sodium silicate.

6. The insulating material according to claim 1, wherein the aqueous solution of silicate is an aqueous solution of potassium silicate.

7. The insulating material according claim 1, wherein the material further comprises a water glass hardener.

8. The insulating material according to claim 1, wherein the water glass stabilizers are hydrophilic alkoxy alkyl-ammonium salts.

9. A method of production of the non-flammable thermally insulating material according to claim 1, wherein as the first step, the water glass stabilizer is added into the aqueous solution of silicate and, at the same time in a second step, a mixture of phenyl methyl diisocyanate and branched polyol is prepared and then the aqueous solution of silicate is intermixed with the mixture of phenyl methyl diisocyanate and branched polyol and thereafter the hollow glass spheres are added into the resulting mixture and everything is then thoroughly mixed again.

10. The method of production of the insulating material according to claim 9, wherein the water glass hardener is added into the aqueous solution of silicate and water glass stabilizer.

11. The method of production of the insulating material according to claim 9, wherein the resulting mixture is then poured in a silicone mould and left undisturbed until it becomes hardened.
